(19) United States
(12) Patent Application Publication
(10) Pub. No.: US 2010/0178386 A1
(43) Pub. Date: Jul. 15, 2010

(54) TRANS FATTY ACID FREE FAT FOR FRYING PRODUCED BY ENZYMATIC INTERESTERIFICATION AND METHOD FOR PREPARING THE SAME

(75) Inventors: Sang-Bum Lee, Seoul (KR); Chul-Jin Kim, Ulsan (KR); Ji-Hyun Kang, Seoul (KR); Sang-HOON Song, Bucheon-Si (KR); Kang-Pyo Lee, Seoul (KR); Young-Chan Kim, Incheon (KR); Ki-Taek Lee, Daejeon (KR)

Correspondence Address: BIRCH STEWART KOLASCH & BIRCH, PO BOX 747, FALLS CHURCH, VA, 22040-0747, US

(73) Assignee: CJ CHEILJEDANG CORP., Seoul (KR)

(21) Appl. No.: 12/516,938

(22) PCT Filed: Nov. 29, 2007
(86) PCT No.: PCT/KR2007/006087

§ 371 Date: Mar. 25, 2010

(30) Foreign Application Priority Data
Nov. 29, 2006 (KR) 10-2006-0119349

(51) Int. Cl. A23D 9/02

(52) U.S. Cl. 426/33; 426/607

(57) ABSTRACT

The present invention can provide frying oil with the enzymatic interesterification reaction, in which trans fatty acid is not formed in the process different from the existing partially hydrogenerated oil and the frying oil contains less than 1% of trans fatty acid content and less than 27% of palmitic acid based on total fatty acid content and has solid fat content at temperature of 37.8° C. and melting point corresponding to that of partially hydrogenerated oil. Accordingly, the frying oil of the present invention is eco-friend and has lower trans fatty acid compared to the existing partially hydrogenerated oil and has higher triglyceride content without side reaction, and is also nutritionally excellent since it has lower palmitic acid content than natural palm oil which is usually used as a substitute for the existing frying oil such as partially hydrogenerated oil, and has taste corresponding to partially hydrogenerated oil.

### TECHNICAL FIELD

The present invention relates to frying oil having lower trans fatty acid prepared by the enzymatic interesterification reaction, more particularly, to frying oil which is prepared by formulating palm oil, soybean oil and the complete hydrogenated oil at a constant ratio followed by performed the enzymatic interesterification reaction and thus trans fatty acid, different from the existing partially hydrogenerated oil, is not formed in the process, and it contains more than 99% of triglyceride, less than 1% of diglyceride and monoglyceride, less than 1% of trans fatty acid based on total tatty acid, less than 27% of palmitic acid, and the melting point and the content of solid fat at 37.8° C. are equivalent with the partially hydrogenerated oil.

### BACKGROUND ART

Trans fatty acid is a general term for unsaturated fatty acids having at least 1 of trans-type double bond. Most of double bond existing in natural oil have cis-form structure. Cis-form fatty acids exist in the form of liquid at room temperature since alkyl groups are positioned in the same direction based on the double bound to form a loose spatial structure between molecules and thus stability is lowered to some degree and melting point is also lowered. On the other hand, trans fatty acid exist in the form of solid at room temperature like saturated fatty acid since alkyl groups are opposite with each other based on the double bound to form stable molecular structure.

A major source of trans fatty acid contained in food is hydrogenated oil which is partially or selectively added hydrogen for increasing melting point of oil. Up to the present, improvements of crystal and flow properties of vegetable oil which is used as material for margarine and shortening, have been achieved by the hydrogenation.

The hydrogenation for transforming oil in state of liquid to fat in state of solid was attempted early in the nineteen hundreds in Europe and thus it was used as a substituted product for lard.

Before the second world war, palm oil, suet or lard was used as a substituted product for butter, after that time a demand for the hydrogenation of vegetable oil has drastically begun to increase and it was used as a major solid fat for margarine and shortening product. The hydrogenation is a process performed in the industrial field for the purpose of improving oxidation stability, increasing melting point and brightness of oil.

With the progress of hydrogen bond, double bond is saturated and constituents of oil which is sensitive to the oxidation by air are reduced. Generally, the higher the degree of unsaturation, the lower melting point of oil. Since melting point of oil is increased with the saturation of double bond due to the addition of hydrogen, if oil is completely hydrogenerated, the highest melting point is obtained. However, in practice, most of oil is partially hydrogenerated. The first object of hydrogeneration is to prevent a nasty smell or acidification occurred in reaction of oil with oxygen in the air, improving oxidative stability of oil. The second object is to improve physical properties of oil in order to make easy to process it. Controlling melting property via hydrogeneration, it can be possible to produce shortening having a wide range of plasticity, or margarine having good ductility and taste by its specific melting point. Although high degree of saturation in double bond is important factor for increasing melting point of oil and determining melting characteristics, but considerable amount of double bond in fatty acid which is not hydrogenerated, are transformed from cis-form to trans-form by geometric isomerization, and thus they contains more trans fatty acid than the amount discovered in natural.

A part of trans fatty acid is also produced with a small amount during a deodorization process which is a final step of oil purification process treated with high temperature. The deodorization process is essential step in the edible oil purification process in which a scent component in oil is removed and thus a taste is improved and microbiological stability is guaranteed. Trans fatty acid content produced in the deodorization process is determined by initial unsaturated fatty acid content of oil and an operating condition of the process.

On the other hand, most of natural oil contains unsaturated fatty acid in which double bond is constructed with cis-form, but there is also natural trans fatty acid obtained from a ruminant such as cattle or sheep. In the ruminant stomach, about 4% or so of trans fatty acid is produced through metabolism, accordingly, a small amount of trans fatty acid is produced from milk and dairy products, and suet which have been taken by human being for a long time.

Trans fatty acid which do not exist in the natural state, because a system for receiving them is not constructed in the human body, have unfavorable side effects as is act as a foreign substance in the human body or is accumulated in other site of the cell membrane such that it is presumed as the origin caused several disorders. Also, trans fatty acid is considered to weaken a construction and functionality of the cell membrane. That is to say, trans fatty acid causes a trouble in the normal entrance of mineral and other nutrients which enter and leave the cell membrane to weaken the cell and to reduce a immunity in human body and thus it increases a danger of arteriosclerosis and cardiovascular diseases. Also, it was reported that trans fatty acid interferes the normal transformation of cholesterol which is conducted in the liver to increase the cholesterol concentration in the blood. Furthermore, it causes an increase of low density lipoprotein (LDL) value and a reduction of high density lipoprotein (HDL) value, in which LDL, a bad cholesterol, is mainly responsible for causing arteriosclerosis, and HDL, a good cholesterol, protects the human body from the danger of LDL. It is point out that trans fatty acid causes more serious health problem than saturated fatty acid.

A method for reducing trans fatty acid includes oil modification method such as fractional distillation and interesterification, improvement of hydrogeneration method and deodoration method, and use of natural oil.

Among them, fractional distillation, as using physical properties of oil, has advantage of concerning to oil affect, however it has limited to use in raw material for margarine and shortening because its solid fat value is solid to temperature change, and it also has a defect that coarse crystal can be formed in case of using in excess. Improvement of hydrogeneration can adjust conditions and a degree of hydrogeneration to achieve the reduction of trans fatty acid, but it is impossible to completely reduce trans fatty acid.

By improving the deodoration method, it can be possible to effectively reduce trans fatty acid, but such improvement is only supplementary measures since it cannot reduce trans fatty acid existing before the deodoration like in hydrogenerated oil.

By using a liquid type natural oil such as soybean oil, corn oil, olive oil, grape seed oil, canola oil and cottonseed oil for cooking, it can be possible to substitute for hydrogenerated oil, but it cannot fulfil solid fat value demanded in margarine and shortening. Also, other natural oil such as palm oil and coconut oil cannot completely substitute for hydrogenerated oil.

Interesterification technique which is a technique for reducing trans fatty acid and an alternative technique for hydrogeneration, is considered worldwide development.

Although interesterification technique is necessary for having a new installation and for ensuring a diversity of technical know-how, it is suitable to substitute for a variety of hydrogenerated oil and can fulfil solid fat value necessary for margarine and shortening.

Interesterification is divided into Chemical interesterification (CIE) and Enzymatic interesterification (EIE) based on catalyst being used. Since there is no need to add any chemical reagent and no formation of harmful by-product, EIE which is not need to add any chemical reagent and is formed none of harmful by-product, is a reforming technique which eco-friendly induces melting point inflection curve, and oil produced by EIE has high triglyceride content an thus it can be used for cooking. However, CIE, as using chemical catalyst, bring about oil loss in the procedure for removing residue sodium soap and is necessary for introducing subsequent purification procedure due to a change of oil color and a residual diacylglycerols (DAG) which are occurred according to the process characteristics. Further, as EIE is occurred at low temperature and has higher reaction particularity compared to CIE, it has a advantage that not only natural antioxidant materials such as tocopherol contained in oil are kept in high level, but the change of fatty acid structure can be achieved through the expression of particularity in EIE which is not embodied by CIE.

Accordingly, it is the worldwide improvement that “enzymatic interesterification technique” which is eco-friendly biomethod is used to produce a high value-added oil product and products having the diversity of use including the cooking use.

For a few year, many researchers have been reported that “enzymatic interesterification technique” was proved to have effect on controlling the solid fat value of oil. However, until recently, such technique did not applied besides to expensive products because of excessive enzyme cost rising occurred by increasing cost of fixation. However, enzymatic interesterification technique can be used for producing industrial bulk oil such as margarine as drastic improvement of fixation technique. The enzymatic interesterification technique can produce the most suitable product in the respect of functionality and health orientation.

The major advantage of enzymatic interesterification technique is that the firstly, process is simple and can be easily controlled, and secondly, a various modification can be endowed to the product, thirdly trans fatty acid does not formed and fourthly more natural product can be produced.

As described above, frying oil produced by the enzymatic interesterification technique contains high triglyceride content and low diglyceride and monoglyceride content without side reaction and has a little bubble in cooking to maintain color of reactant brightly as reacting at low temperature, and natural antioxidant material such as tocopherol containing in oil is preserved with high content such that the frying oil has a potential to use in cooking

Recently in the country, the dispute related to maleficence of trans fat is currently spreaded and thus palm oil substitute for hydrogenerated soybean oil, however an opinion that it is only a temporary expedient, is dominant. It is due to the fact that palm oil contains less than 1% of trans fat but unsaturated fatty acid content is amount to 50%. Saturated fatty acid is known to increase cholesterol value in blood as taking a large amount and thus increasing a morbidity of cardiac diseases. Degree of increasing cholesterol value is different from kind of saturated fatty acid. Stearin acid is preferred in case of need solid fat for raising the degree of perfection in final product, but tropical vegetable oil such as palm oil containing palmitic acid in amount of 40%, is not preferred since there is known that stearin acid neutrally acts to cholesterol value but palmitic acid increases cholesterol value in blood.

In the development of frying oil, solid fat content at melting point and 37.8° C. is important. Though solid fat is necessary for raising a degree of perfection in the final cooked product, its content should be equivalent with that of partially hydrogenerated oil at melting point and 37.8° C. because a taste on melting in the mouse is lowered when the content at melting point and 37.8° C. is high.

In the prior art, the Korean Published Patent Application No. 10-2006-0037257 which is a method for the hydrolysis of oil to have a low trans fatty acid content, disclosed that hydrolysis is performed for 1 to 6 hours at temperature not exceeding 300° C. The Korean Published Patent Application No. 10-1991-0011143 which is method for preparing margarine oil having trans acid and medium-chain saturated fatty acid content, disclosed an enzymatic interesterification method for preparing a margarine oil comprising the steps of (a) providing a interesterification reaction mixture containing a stearic acid source material selected from the group consisting of stearic acid, stearic acid monoesters of low molecular weight monohydric alcohols, and mixtures thereof, said stearic acid source material comprising at least about 84 weight percent of stearic acid, based on the total weight of fatty acids in said stearic acid source material, and an edible liquid vegetable oil comprising at least about 80 weight percent of esterified eighteen carbon fatty acid moieties based on the total weight of the edible liquid vegetable oil triglyceride, (b) said vegetable oil further comprising less than 7 weight percent of esterified palmitic acid in 2-glyceride position, and less than 4 weight percent of esterified stearic acid in the 2-glyceride position, at least about 20 weight percent of esterified oleic acid in each of the 1, 2 and 3 glyceride positions, at least about 20 weight percent of esterified linoleic acid, at least about 5 weight percent of esterified linolenic acid, and less than 2 weight percent of esterified stearic acid in the 2-position, (c) transesterifying said stearic acid source material and said vegetable oil triglyceride using a 1-, 3-positionally specific lipase, at a weight ratio of stearic acid source material to the vegetable oil triglyceride in the range of from about 0.5:1 to about 2:1 to substantially equilibrate the ester groups in the 1-, 3-positions of the glyceride component with non-glyceride fatty acid components of the reaction mixture, separating transesterified free fatty acid components from glyceride components of the interesterification mixture to provide a transesterified margarine oil product and a fatty acid mixture comprising fatty acids, fatty acid monoesters or mixtures thereof released from said vegetable oil, and (d) hydrogenating the fatty acid mixture to provide a recycle stearic acid source material for recyclic reaction with said vegetable oil triglyceride. Further, the U.S. Pat. No. 5,288,619 disclosed a method for preparing a margarine oil having both low trans-acid and low intermediate chain fatty acid content, comprising the steps of providing a interesterification reaction mixture containing a stearic acid source material and an edible liquid vegetable oil, transesterifying the stearic acid source material and the vegetable oil using a 1-, 3-positionally specific lipase, and then finally hydrogenating the fatty acid mixture to provide a recycle stearic acid source material for a recyclic reaction with the vegetable oil. However, frying oil prepared by interesterification reaction using enzyme has not been reported, and also there was no trial to prepare frying oil containing trans fatty acid and palmitic acid and having physical properties equivalent with partially hydrogenerated oil at 37.8° C.

The present invention is to provide frying oil containing more than 99% of triglyceride, less than 1% of diglyceride and monoglyceride, less than 1% of trans fatty acid based on total tatty acid, less than 27% of palmitic acid, and the melting point and the content of solid fat at 37.8° C. are equivalent with the partially hydrogenerated oil.

According to the present invention, frying oil of the present invention is eco-friendly by using enzyme, and has lower trans fatty acid content than existing partially hydrogenerated oil, and has high triglyceride content without a concomitant reaction, and is dietetically good as having low palmitic acid content compared to palm oil which is natural oil commonly used replacing partially hydrogenerated oil which have been used as frying oil, and have a taste corresponding to partially hydrogenerated oil.

### DISCLOSURE OF INVENTION

### Technical Problem

The present invention is completed by taking notice of the fact that frying oil containing more than 99% of triglyceride content and less than 1% of diglyceride and monoglyceride content can be obtained by controlling water content in mixed oil of solid fat and liquid oil and then carrying out interesterification reaction, and frying oil containing less than 1% of trans fatty acid content and less than 27% of palmitic acid based on total fatty acid content and having solid fat content at temperature of 37.8° C. and melting point corresponding to that of partially hydrogenerated oil can be obtained by mixing solid fat and liquid oil with various ratios and then carrying out interesterification reaction. Accordingly, the object of the present invention is to provide frying oil coincident with the above object by changing the mixing ratio of solid fat and liquid oil and water content in mixed oil.

### ADVANTAGEOUS EFFECTS

The present invention can provide frying oil with the enzymatic interesterification reaction, in which trans fatty acid is not formed in the process different from the existing partially hydrogenerated oil and the frying oil contains less than 1% of trans fatty acid content and less than 27% of palmitic acid based on total fatty acid content and has solid fat content at temperature of 37.8° C. and melting point corresponding to that of partially hydrogenerated oil. Accordingly, the frying oil of the present invention is eco-friend and has lower trans fatty acid compared to the existing partially hydrogenerated oil and has higher triglyceride content without side reaction, and is also nutritionally excellent since it has lower palmitic acid content than natural palm oil which is usually used as a substitute for the existing frying oil such as partially hydrogenerated oil, and has taste corresponding to partially hydrogenerated oil, and thus the present invention is useful in the food industry.

### BRIEF DESCRIPTION OF THE DRAWINGS

FIG. 1 is a graph showing a result of Differential Scanning Calorimeter analysis for determining the possibility of the enzymatic intraesterification reaction by TLIM enzyme, wherein A is related to blend product and B is related to enzymatic formulation.

FIG. 2 is a graph showing a change of solid fat value according to temperature of mixed oil 1 and oil obtained by the enzymatic intraesterification reaction respectively.

FIG. 3 is a graph showing a change of solid fat value according to temperature of mixed oil 2 and oil obtained by the enzymatic intraesterification reaction respectively.

FIG. 4 is a graph showing a change of solid fat value according to temperature of mixed oil 3 and oil obtained by the enzymatic intraesterification reaction respectively.

FIG. 5 is a gas chromatograph showing a result of separating fatty acid from frying oil of the present invention.

FIG. 6 is a gas chromatograph showing a result of separating fatty acid from frying oil of the existing partially hydrogenerated oil.

### BEST MODE FOR CARRYING OUT THE INVENTION

In order to achieve the above object, it can be used both of solid fat or liquid oil well known in the art as material oil in preparing frying oil having lower trans fatty acid of the present invention.

Solid fat includes, for example, completely hydrogenerated soybean oil, completely hydrogenerated suet, palm oil, palm stearin oil, palm olein oil, palm nuclei oil, palm nuclei olein oil, hydrogenerated coconut oil, coconut oil or cottonseed stearin oil. Liquid oil includes, for example, soybean oil, corn oil, cottonseed oil, rapeseed oil, sunflower oil, grape seed oil or olive oil. Preferably, it can be used one or more selected from the group consisting of palm oil, soybean oil and completely hydrogenerated oil. Water content in mixing oil of solid fat and liquid oil is controlled to prepare frying oil having more than 99% of triglyceride and less than 1% of diglyceride and monoglyceride.

In the present invention, it is preferred to obtain a material oil by formulating palm oil, soybean oil and completely hydrogenerated oil in the ratio of 4.5˜5.5:3.5˜4.3:0.2:2.0.

The obtained source oil is then processed by the enzymatic interesterification reaction to produce frying oil of the present invention which comprises less than 1% of trans fatty acid, less than 27% of palmitic acid based on total weight of fatty acid, and has melting point and content of solid fat at 37.8° C. corresponding to that of partially hydrogenerated oil.

Frying oil of the present invention can be prepared by the enzymatic interesterification reaction.

Frying oil of the present invention contains less than 1% preferably 0.1 to 1% of trans fatty acid based on total weight of fatty acid.

Frying oil of the present invention contains more than 99%, and less than 1% of diglyceride and monoglyceride.

Frying oil of the present invention contains less than 27%, preferably 10 to 27% of palmitic acid based on total weight of fatty acid.

Frying oil of the present invention contains less than 20%, preferably 14 to 20% of solid fat.

Frying oil of the present invention has less than 40° C. of melting point and less than 4% of the solid fat value at the temperature of 37.8° C.

In the present invention, unless specified otherwise, a symbol “%” means “weight %”.

In order to ascertain the possibility of interesterification using enzyme, analysis by Differential Scanning Calorimeter (DSC) was done.

By Differential Scanning Calorimeter (DSC), melting profile after and before interesterification using enzyme can be measured by which the possibility of interesterification can be ascertained. The analytical condition of Differential Scanning Calorimeter (DSC) listed below on table 1:

TABLE 1
The analytical condition of Differential
Scanning Calorimeter(DSC)

| | |
|---|---|
| Name | DSC 2010 |
| Temperature | −60~80° C. |
| Cooling rate | 10° C./min(below to −60° C.) |
| Temperature increasing rate | 5° C./min(up to 100° C.) |
| Amount of sample | 8 ± 0.1 mg |

The analysis of solid fat content was done by the Parallel Method using Nuclear Magnetic Resonance (NMR). As the pre-treatment, six samples obtained by enzymatic interesterification were completely melted at 100° C., and left for 5 minutes at 60° C. and for 60 minutes at 0° C. A total time for the pre-treatment took about 80 minutes. The obtained samples were kept for 30 minutes in the Celsius bath-metal block thermostat pre-settled at 10.0° C., 21.1° C., 26.7° C., 33.3° C. and 37.8° C. and measured for about 6 seconds. An analysis of Solid fat content by Nuclear Magnetic Resonance (NMR) was done with conditions described in table 2.

TABLE 2

| | |
|---|---|
| Name | Bruker. the minispec |
| Frequency | 60 MHz |
| Amount of sample | 6 mL |
| Pretreatment temperature | 100° C., 0° C. |
| Experimental temperature | 10.0° C., 21.1° C., 26.7° C., |
| | 33.3° C. and 37.8° C. |

Melting point analysis was done to quickly measure the degree of reaction and physical properties after mixing with substrate. Melting point was measure with EX-871 automatic raising melting point tester. Completely melted sample was filed in a capillary tube with about 1 cm and then the capillary tube was put into a support, and left in a freezer for about 10 minutes. Distilled water prepared in advance at 10° C. was poured into a bath of melting point tester, and sample was put into a sensor of tester, and then the melting point was measured. temperature was raised with 2° C./min at 10˜25° C. and after 25° C. raised with 0.5° C./min. Conditions of the melting point measurement analysis using the automatic raising melting point tester were listed below table 3.

TABLE 3
Conditions of the melting point measurement analysis
using the automatic raising melting point tester

| | |
|---|---|
| Name | EX-871 automatic raising melting point |
| | tester |
| Temperature raising rate | 0.5° C./min |
| The number of sample | 8 |
| Condition of pre-treatment | −5° C.(10 min.) |
| Detecting instrument | special photoelectric sensor detecting |
| | method |
| Heating apparatus | special coil-type heating heater 400 W |
| Stirring apparatus | adjustable speed motor |

The trans fatty acid content and the palmitic acid content were analysed with following conditions:

The Liquid standard of SIGMA was used as reference standard, and all of reagent necessary for the analysis were special grade. In order to methylate samples obtained by the enzymatic interesterification, 0.025 mg of sample was added into 1.5 mL of 0.5N NaOH-methanol, and heated for about 5 minutes on the heating block, and then cooled in 30˜40° C. of the constant temperature bath. 2 mL of BF₃-methanol solution was added, and boiled for 30 minutes on the heating block, and then cooled in 30˜40° C. of the constant temperature bath. The resulting mixture was mixed with a solution of iso-octane 1˜2 mL and saturated NaCl, and left. Upper layer was separated and dried over dehydrated sodium sulfate, and then residue was used as sample. Conditions of fatty acid analysis using Gas Chromatography (GC) were listed in below table 4.

TABLE 4
Conditions of fatty acid analysis using Gas Chromatography(GC)

| Name | Agilent 6890N GC | |
|---|---|---|
| Column | SPTM-2560(Fused-silica capillary | |
| | column) 100 m × 0.25 mm I.d., 0.2 μm | |
| Detector | FID(Flame Ionization Detector) | |
| Amount of sample | 1 | μL |
| Temperature of nozzle | 250° | C. |
| Temperature of detector | 280° | C. |
| Temperature of oven | 180° | C. |

| | |
|---|---|
| Carrier gas | N₂(1 mL/min) |

Contents of DG, MG and TG was measured with TLC-FID. TLC-FID is the instrument which can be used in the quantitative and qualitative analysis of organic mixture separated on thine layer chromatography. Solvent for analysis was a special grade reagent from SIGMA. After dissolving sample in solvent, about 10 μL of obtained mixture was spotted on chroma-rod specially designed for TLC-FID (quartz rod having sticked silica or alumina at a high temperature for separating and developing sample). Sample was developed in the development bath having developing solvent for 20 minutes, and then completely dried off solvent in the drying oven, and analyzed using TLC-FID. The analysis conditions by TLC-FID was listed in below table 5.

TABLE 5
The analysis conditions by TLC-FID

| Name | IATRON IATROSCAN MK-5 | |
|---|---|---|
| Detector | FID(Flame Ionization Detect) FPD(Frame | |
| | Photometric Detect) | |
| Amount of sample | 1 | μL |
| Hydrogen flow rate | 160 | mL/min |
| Air flow rate | 2 | mL/min |
| Scan speed | 30 | sec |

### Experimental Example 1

### Selection of Enzyme

Lypozyme TLIM (Novozymes, Denmark), which is lipase from Termomyces lanuginosus is fixed into porous silica granule and is insoluble to oil. In order to compare characteristics between TLIM of the present example and RMIM (Lipozyme RMIM) (Novozymes, Denmark) well known in the art, the degree of binding with capric acid over time was measured, and the result was demonstrated in below table 6.

TABLE 6
The binding degree of TLIM and RMIM with capric acid over time

| Time | RMIM | TLIM |
|---|---|---|
| 2 | 6.85 | 5.33 |
| 4 | 16.20 | 14.11 |
| 6 | 21.23 | 20.21 |
| 8 | 26.17 | 25.53 |
| 10 | 30.18 | 27.41 |
| 12 | 31.92 | 30.76 |
| 24 | 35.33 | 35.41 |

As a result of the reaction, RMIM enzyme showed somewhat higher reaction rate than TLIM enzyme for 12 hours of reaction time, however after 24 hours RMIM enzyme and TLIM enzyme showed equivalent reaction rated with 35.33 mol % and 35.41 mol % respectively. Accordingly, it is found out that TLIM enzyme is mere effective from relatively economical point of view.

### Experimental Example 2

### Search for the Possibility of the Interesterification Reaction by the Selected Enzyme

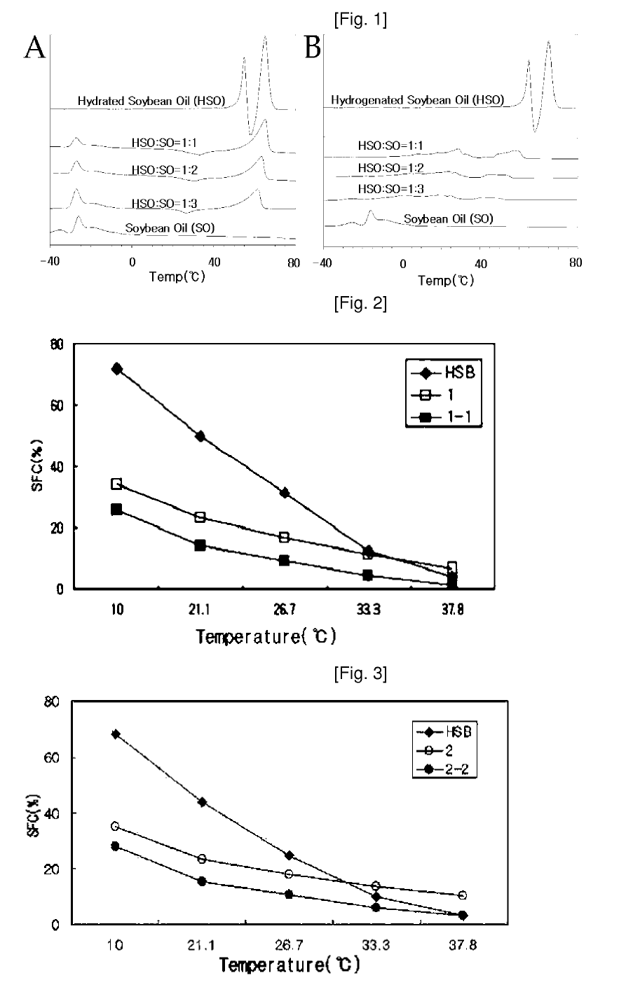

In order to investigate the possibility of the interesterification reaction by the selected TLIM enzyme, the enzyme was filled into the self-made column made out of glass and mixed oil was continuously flowed through them. At that time, reaction temperature was 55˜70° C. After completing the reaction, analysis was performed with the Differential Scanning Calorimeter. The Melting Profile was measured with the Differential Scanning Calorimeter before and after the interesterification reaction by the enzyme. The Melting Profile before the reaction obviously showed two peaks which are characteristics of soybean oil and completely hydrogenerated soybean oil, however that of after the reaction showed a slow melting profile substituted for characteristic peaks (FIG. 1). It means that soybean oil and completely hydrogenerated soybean oil are transesterificated by the enzyme to form a new oil. Thus, it can be known that the possibility of the reaction is sufficient.

### Experimental Example 3

### Examine for TG, DG and MG Content in Frying Oil

Glyceride content in mixed oil according to water content was analysed by using the fact that contents of triglyceride content, diglyceride and monoglyceride can be controlled after the enzymatic interesterification reaction by controlling water content in mixed oil. Mixed oil was prepared by mixing palm oil, soybean oil and completely hydrogenerated soybean oil in the ratio of 5.0:4.0:1.0. Each glyceride content were showed in below table 7. As a result of the analysis, when water content in mixed oil was less than 0.02% before the enzymatic interesterification reaction, frying oil containing more than 99% of triglyceride, less than 1% of diglyceride and monoglyceride can be obtained.

TABLE 7

| Water content in mixed | Triglyceride content | Diglyceride + mono- |
|---|---|---|
| oil(%) | (%) | glyceride content (%) |
| 0.01 | 99.3 | 0.7 |
| 0.02 | 99.2 | 0.8 |
| 0.05 | 98.7 | 1.3 |

### Experimental Example 4

### Development of Frying Oil

In order to obtain frying oil having lower trans fatty acid, partially hydrogenerated soybean oil was analysed. It was examined that partially hydrogenerated soybean oil had physical properties as shown in table 8 and contained about 38% of trans fatty acid. Since a taste is most important property in frying oil, the present example lay stress on solid fat content in the melting point and temperature of 37.8° C.

Mixed oil 1 made up of palm oil, soybean oil and completely hydrogenerated oil in the ratio of 5.5:4.3:0.2 was transesterificated with the selected TLIM enzyme to prepare reaction oil 1 and then solid fat value (solid fat content) according to the temperature was examined. The result was showed in below table 8 and FIG. 2.

TABLE 8

| | Melting point(° C.) | Solid fat content at 37.8° C. |
|---|---|---|
| HSO | 38.5 | 3.4 |
| Mixed oil 1 | 46.3 | 6.6 |
| Reaction oil 1 | 37.1 | 1.6 |

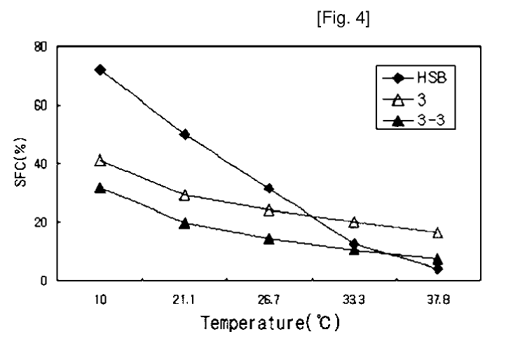

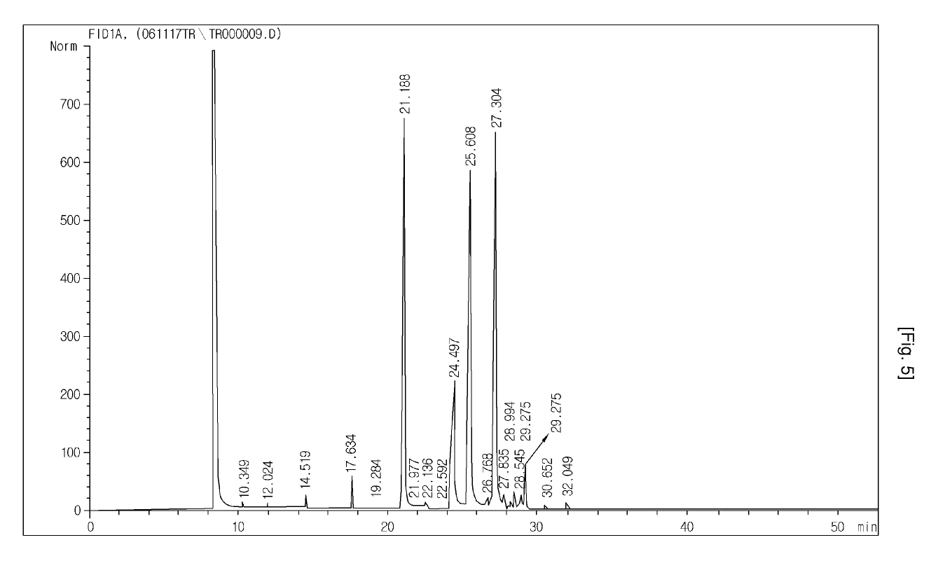

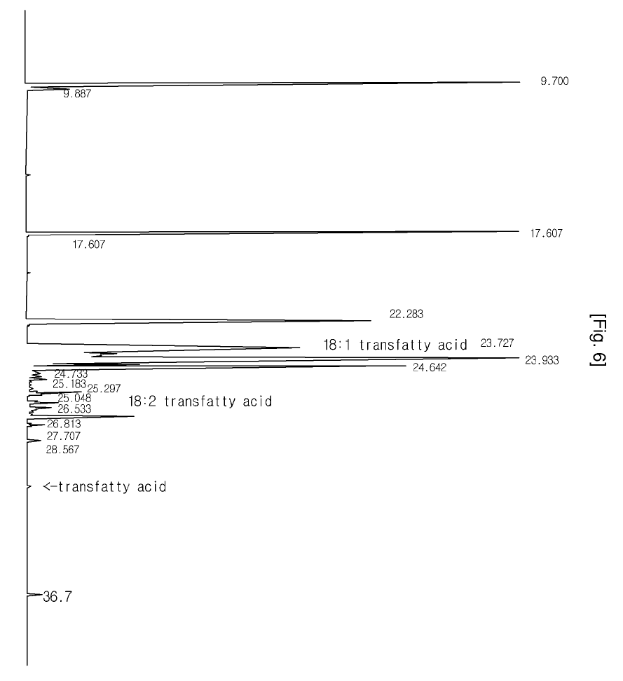

It can be known that reaction oil 1 which is resulted from the enzymatic interesterification reaction of mixed oil 1, had somewhat lower solid fat content at melting point and 37.8° C. compared to partially hydrogenerated soybean oil. Accordingly, by increasing solid fat content of mixed oil 1, mixed oil 2 made up of palm oil, soybean oil and completely hydrogenerated oil in the ratio of 5.0:4.0:1.0 and mixed oil 3 made up of palm oil, soybean oil and completely hydrogenerated oil in the ratio of 4.5:3.5:2.0 were prepared respectively, and then they were transesterificated with the selected TLIM enzyme to prepare reaction oil 2 and 3 and then solid fat value (solid fat content) according to the temperature was examined. The result was showed in below tables 9 and 10 and FIGS. 3 and 4.

TABLE 9

| | Melting point(° C.) | Solid fat content at 37.8° C. |
|---|---|---|
| HSO | 38.5 | 3.4 |
| Mixed oil 2 | 53.9 | 10.5 |
| Reaction oil 2 | 39.1 | 3.4 |

TABLE 10

| | Melting point(° C.) | Solid fat content at 37.8° C. |
|---|---|---|
| HSO | 38.5 | 3.4 |
| Mixed oil 3 | 60.9 | 16.5 |
| Reaction oil 3 | 42.9 | 7.4 |

In case of reaction oil 2 prepared by the enzymatic interesterification reaction of mixed oil 2, it can be known that solid fat content at melting point and temperature of 37.8° C. was similar to that of partially hydrogenerated soybean oil. As shown in the result, it can be confirmed that frying oil having lower trans fatty acid which is capable of replacing partially hydrogenerated soybean oil, can be prepared by the enzymatic interesterification reaction.

### Experimental Example 5

### Fatty Acid Content in Frying Oil

Mixed oil 2 obtained from the experimental example 4 was transesterificated with enzyme to prepare reaction oil 2, i.e. frying oil having lower trans fatty acid and containing solid fat content at melting point and temperature of 37.8° C. equivalent to that of partially hydrogenerated soybean oil. Gas chromatography was used to examine trans fatty acid content and palmitic acid content in frying oil. The result was shown in below table 11. As shown in table 11, both trans fatty acid contents in mixed oil 2 and reaction oil 2 were less than 1% and palmitic acid contents were less than 27%. According to the result, it can be known that the enzymatic interesterification reaction did not produce trans fatty acid in the process.

TABLE 11

| | | Content (%) | |
|---|---|---|---|
| | Fatty acid | Mixed oil 2 | Reaction oil 2 |
| General fatty acid | Caprylic 8:0 | 0.06 | 0.05 |
| | Capric 10:0 | 0.05 | 0.04 |
| | Laulic 12:0 | 0.38 | 0.35 |
| | Myristic 14:0 | 0.63 | 0.67 |
| | Palmitic 16:0 | 26.17 | 26.25 |
| | Palmitoleic 16:1 | 0.13 | 0.14 |
| | Stearic 18:0 | 12.02 | 12.15 |
| | Oleic 18:1 | 29.34 | 29.24 |
| | Linoleic 18:2 | 26.41 | 26.42 |
| | Linolenic 18:3 | 2.43 | 2.47 |
| | Arachidic 20:0 | 0.42 | 0.40 |
| Trans fatty acid | 18:2 TC | 0.21 | 0.18 |
| | 18:2 CT | 0.14 | 0.15 |
| | 18:3 TTT | 0.22 | 0.25 |
| | 18:3 TCT | 0.29 | 0.27 |
| | 18:3 TCC | 0.10 | 0.12 |

| | | |
|---|---|---|
| Total trans fatty acid (%) | 0.96 | 0.97 |

### Experimental Example 6

### Determination of Properties as Frying Oil

Frying oil having lower trans fatty acid obtained above was compared with the existing frying oil, such as hydrogenerated soybean oil and palm oil. The result was shown in below table 12.

Frying oil having lower trans fatty acid which is obtained by the enzymatic interesterification reaction, had equivalent value in water content, acid value, color value, peroxide value with hydrogenerated soybean oil and palm oil, and had most excellent property in heating loss after experiment of heating forming. It can be recognized that frying oil having lower trans fatty acid which is obtained by the enzymatic interesterification reaction, contained more than 99% of triglyceride, less than 1% of diglyceride and monoglyceride and thus side reaction did not occur in the enzymatic interesterification reaction and bubble level produced in cooking was equivalent with the existing frying oil, such as hydrogenerated soybean oil and palm oil. Such result means that frying oil having lower trans fatty acid which is obtained by the enzymatic interesterification reaction is suitable for frying oil.

TABLE 12

| | | Frying oil having | |
|---|---|---|---|
| | Hydrogenerated | lower trans fatty | |
| | soybean oil | acid | Palm oil |
| Water content | 0.015 | 0.019 | 0.028 |
| Acid value | 0.41 | 0.40 | 0.38 |
| Color value | 10/1.0 | 10/1.0 | 15/1.5 |
| Peroxide value | 9.41 | 1.82 | 11.78 |
| Heating loss | 1.54 | 0.78 | 1.83 |

1. A method for preparing frying oil which is characterized in mixing one or more oil selected from the group consisting of palm oil, soybean oil and completely hydrogenerated oil to produce a source oil, and treating the resulting source oil with the enzymatic interesterification reaction.

2. The method according to claim 1, which is characterized in that the source oil is obtained by mixing palm oil, soybean oil and completely hydrogenerated oil in the ratio of 4.5˜5.5:3.5˜4.3˜0.2˜2.0.

3. The method according to claim 1, which is characterized in that water content in the source oil is less than 0.02% before the enzymatic interesterification reaction.

4. A frying oil which is characterized in containing 0.1˜1% of trans fatty acid, more than 99% of triglyceride, and 10˜27% of palmitic acid.

5. The frying oil according to claim 4, in which the frying oil has 14˜20% of solid fat content.

6. A frying oil prepared by the method of claim 1 having 0.1˜1% of trans fatty acid content.

7. A frying oil prepared by the method of claim 2 having 0.1˜1% of trans fatty acid content.
